(19) United States
(12) Patent Application Publication
(10) Pub. No.: US 2024/0059102 A1
(43) Pub. Date: Feb. 22, 2024

(54) REINFORCED FABRIC COMPRISING A PLURALITY OF METAL REINFORCING ELEMENTS

(71) Applicant: COMPAGNIE GENERALE DES ETABLISSEMENTS MICHELIN, Clermont-Ferrand (FR)

(72) Inventors: XAVIER DEPARIS, Clermont-Ferrand (FR); JEAN-MATHIEU CLERGEAT, Clermont-Ferrand (FR)

(21) Appl. No.: 18/267,952

(22) PCT Filed: Nov. 29, 2021
(86) PCT No.: PCT/FR2021/052117

§ 371 Date: Jun. 16, 2023

(30) Foreign Application Priority Data
Dec. 22, 2020 (FR) 2013934

(51) Int. Cl. B60C 9/18; B60C 9/00

(52) U.S. Cl. CPC B60C 9/1821; B60C 9/0007; B60C 2009/0085; B60C 2009/2067

(57) ABSTRACT

A reinforced fabric comprises a plurality of metal reinforcing elements arranged in a transverse direction, substantially parallel to each other and extending in a main direction perpendicular to the transverse direction, embedded in an elastomer composition based on at least one elastomer, a reinforcing filler, and a crosslinking system, each metal reinforcing element having, in a plane perpendicular to the main direction, a cross-section inscribed in a rectangle of length W and a height T.

### TECHNICAL FIELD OF THE INVENTION

The present invention relates to the field of reinforced fabrics, particularly reinforced fabrics used in pneumatic tires, and to the field of pneumatic tires.

### PRIOR ART

A pneumatic tire with a radial carcass reinforcement for a passenger vehicle or van comprises, as is known, a tread, two inextensible beads, two flexible sidewalls connecting the beads to the tread, and a rigid crown reinforcement or “belt” arranged circumferentially between the carcass reinforcement and the tread.

The crown reinforcement comprises a plurality of reinforced fabrics, known as plies, and generally consists of at least two superposed, crossed rubber plies known as “working plies”, “triangulation plies” or “working reinforcements”, usually reinforced with metal cables positioned substantially parallel to each other and inclined relative to the circumferential mid-plane of the pneumatic tire, and a rubber ply situated above the working plies (on the tread side), known as the “hooping ply” or “hoop reinforcement”, which is generally reinforced with reinforcing threads known as “circumferential”, the main function of which is to withstand the centrifuging of the crown at high speeds. These plies can optionally be associated with other rubber plies and/or fabrics. The main function of the working plies is to give the tire high drift thrust or cornering stiffness which, as known, is necessary for achieving good handling on the motor vehicle.

Such belt structures, which ultimately consist of a multilayer composite laminate comprising at least one hooping ply, usually textile, and two working plies, generally metal, are well known to a person skilled in the art and do not need to be described in greater detail here. Such belt structures are illustrated for example in U.S. Pat. No. 4,371,025 and FR 2 504 067.

The availability of increasingly strong and durable steels means that nowadays tire manufacturers are, as far as possible, tending towards the use in tire belts of cables with a very simple structure, in particular having just two threads, or even of individual filaments, in order to simplify manufacturing and reduce costs, and to reduce the thickness of the reinforcing plies and thus the hysteresis of the tires, and ultimately to reduce the energy consumption of the vehicles fitted with such tires.

However, efforts aimed at reducing the mass of the tires, in particular by reducing the thickness of their belt and of the layers of rubber from which it is made do, quite naturally, come up against physical limits that can give rise to a number of difficulties. In particular, it sometimes happens that the hooping function afforded by the hoop reinforcement and the stiffening function afforded by the working reinforcement are no longer sufficiently differentiated from each other and can interfere with each other. This is detrimental to the correct operation of the crown of the tire, and to the performance and overall durability of the tire.

Patent applications WO 2013/117476 and WO 2013/117477 thus proposed a multilayer composite laminate with a specific structure that makes it possible significantly reduce the weight of the belt of the tires, and therefore reduce their rolling resistance, while overcoming the aforementioned drawbacks, made up of a textile hooping ply and two working plies comprising metal monofilaments. WO2019/020888 aims to further reduce the mass of the plies while improving the resistance to buckling, by linking the diameter of the metal monofilaments, the density of said monofilaments and the thickness of the ply.

Other work, such as that disclosed in JP2001/328407, relates to the implementation of metal reinforcing elements the cross-section of which is no longer circular, but inscribed in a rectangle, in order in particular to make the plies thinner, thus making them lighter and resulting in a reduction in the rolling resistance of the pneumatic tire. JP2017/048351 discloses the use of a flat reinforcer the height-to-width ratio of which is preferably between 0.4 and 0.5 with an inter-cable distance, that is, the distance between two consecutive reinforcing elements, of between 0.15 and 0.54 mm, associated with a specific elastomer composition in order to reduce the rolling resistance, limit heating problems and avoid ply separation problems.

However, the increased weight and improved performance of vehicles require, inter alia, in an increase in the breaking force of the plies. This force can be increased for example by increasing the mechanical strength of the metal reinforcers, with the limits inherent in the availability of steels, or by increasing the diameter and/or the density of these reinforcers, which can result in an increase in the thickness and/or mass of the plies, and therefore the weight of the pneumatic tire, and/or a reduction in the space separating two consecutive metal reinforcing elements within a ply. It then becomes difficult to fill the rubber bridges situated between the reinforcing elements, which can be detrimental to the durability of the ply or plies and therefore of the pneumatic tire, particularly due to the risk of splitting, which corresponds to the appearance of cracks propagating between the working plies. The reduction of the inter-cable distance can also make the plies difficult to manufacture, as it requires that a large number of metal threads be placed parallel to each other a small distance apart.

Continuing its research, the applicant has discovered a specific configuration of fabric reinforced with metal reinforcing elements having very good breaking strength, lower rolling resistance and a sufficient inter-cable distance to avoid any splitting problems compared to the reinforced fabrics of the prior art.

### DETAILED DESCRIPTION OF THE INVENTION

### Definitions

Main direction is given to mean the direction in which the largest dimension of a metal reinforcing element extends, coincident with the axis of the reinforcing element.

Transverse direction is given to mean a direction perpendicular to the main direction.

Substantially is given to mean within the limits of mechanical tolerance or measurement methods.

The compounds comprising carbon mentioned in the description can be of fossil or biobased origin. In the latter case, they can result, partially or completely, from biomass, or be obtained from renewable raw materials resulting from biomass. This relates in particular to polymers, plasticizers, fillers, etc.

Reinforced Fabric

The invention relates to a reinforced fabric comprising a plurality of substantially parallel metal reinforcing elements extending in a main direction, arranged in a transverse direction perpendicular to the main direction at a laying pitch p expressed in mm, embedded in an elastomer composition based on at least one elastomer, a reinforcing filler, and a crosslinking system, each metal reinforcing element having, in a plane perpendicular to the main direction, a cross-section inscribed in a rectangle of length W and height T and having a breaking strength R_{F} expressed in MPa and measured in accordance with ISO 6892:1984, said fabric having a breaking force expressed in N/mm equal to Rₙ, wherein the laying pitch of the metal reinforcing elements is p≥0.8. R_{F}/Rₙ·(a·1+π/4)·T², where a=W/T and 1/a ranges from 0.35 to 0.75.

It has become apparent that such features make it possible to satisfactorily fill the rubber bridge between two consecutive reinforcing elements while reducing the weight of the reinforced fabric compared to the reinforced fabrics of the prior art, while retaining particularly advantageous “edgewise” and “out-of-plane” breaking strength and stiffness properties.

As is known to a person skilled in the art, the laying pitch is defined as the distance between the geometric centers of two immediately adjacent metal reinforcing elements, measured in the transverse direction.

Preferably, the laying pitch p is such that p≤1.2. R_{F}/Rₙ·(a−1+π/4)·T². When the pitch becomes too large, the collaboration between the juxtaposed metal reinforcing elements deteriorates when the fabric is used as a working ply in a pneumatic tire.

Very preferably, the laying pitch p is such that 0.9. R_{F}/Rₙ·(a−1+π/4)·T²≤p≤1.1. R_{F}/Rₙ·(a−1+π/4)·T².

### Reinforcing Element

Each reinforcing element is metal. Preferably, the reinforcing element comprises a steel core covered with a metal coating layer made from a metal other than steel in order for example to improve the workability of the reinforcing element, or the usage properties of the reinforcing element and/or of the tire, such as the properties of adhesion, corrosion resistance or resistance to aging. For example, the metal of the metal coating layer is selected from zinc, copper, tin and the alloys of these metals. Examples of alloys of these metals include brass and bronze.

The steel can have a pearlitic, ferritic, austenitic, bainitic, or martensitic microstructure or a microstructure resulting from a mixture of these microstructures.

According to one preferred embodiment, when a carbon steel is used, its carbon content (% by weight of steel) is in a range from 0.2% to 1.2%; according to another preferred embodiment, the carbon content of the steel is in a range from 0.6% to 0.8%.

The invention relates in particular to high tensile (HT) steel cord, preferably super high tensile (SHT) or even ultra high tensile (UHT), in which case the reinforcing elements have a tensile strength (R_{F}) that is preferably greater than or equal to 3,650-2,000·D, where D, expressed in mm, is equal to (T+W)/2, more preferably greater than or equal to 4,000-2,000·D, and most preferably greater than or equal to 4,350-2,000·D. The total elongation at break (At) of these reinforcers, which is the sum of the elastic elongation and the plastic elongation, is preferably greater than 2.0%.

Preferably, each reinforcing element has a torsional elastic deformation C, expressed as an absolute value, less than or equal to 6 turns per 6 m of metal reinforcer, preferably less than or equal to 3 turns per 6 m of metal reinforcer.

This low elastic deformation makes it possible to obtain a fabric that is sufficiently flat to be easily incorporated into a rubber article, particularly a pneumatic tire. In a preferred arrangement, the reinforcing elements can be positioned in the fabric so as to alternate their elastic deformation, as disclosed in WO2017/203119.

Each metal reinforcing element has a cross-section, in a plane perpendicular to the main direction, inscribed in a rectangle of length W and height T.

Such a reinforcing element is well known per se in the prior art and described for example in JP2001/328407 and DE102015209343. This reinforcing element can be obtained for example by drawing, using substantially rectangular dies, wherein the corners can be rounded, or by crushing a metal reinforcing element with a circular cross-section by passing it through a roller.

Each metal reinforcing element of the fabric according to the invention preferably has a ratio 1/a, representing the ratio of its height, or thickness, T, to its width W, ranging from 0.35 to 0.65, preferably ranging from 0.45 to 0.65. Such a preferred ratio makes it possible to significantly increase the “edgewise” stiffness, that is, in the axial direction of a pneumatic tire comprising such a fabric as the working ply, without substantially modifying the “out-of-plane” stiffness, that is, in the radial direction of a pneumatic tire comprising such a fabric as the working ply, a lower out-of-plane stiffness allowing improved flattening of the pneumatic tire on horizontal ground.

Preferably, each metal reinforcing element has a height, or thickness, T ranging from 0.15 to 0.70 mm, preferably from 0.15 to 0.40 mm, more preferably 0.20 to 0.30 mm. Such a thickness, associated with the other features of the metal reinforcing element, makes it possible to obtain a good compromise between the total thickness of the working ply and its breaking force.

The reinforced fabric preferably has a breaking force Rₙ greater than or equal to 220 N/mm, preferably greater than or equal to 300 N/mm, more preferably between 330 and 470 N/mm. Such breaking strengths are particularly advantageous when the fabric according to the invention is implemented in a pneumatic tire intended to withstand relatively heavy loads, such as modern passenger vehicles, particularly sport utility vehicles, or vans.

The total thickness of the reinforced fabric is equal to the thickness of the metal reinforcing element, to which is added the thickness of the rubber situated on either side of the reinforcing element, known as the “back thickness”, measured in a radial direction, perpendicular to the plane formed by the transverse and main directions. These two back thicknesses, on either side of the reinforcer, can be identical or different, and are denoted “edos_1” and “edos_2”. The total thickness of the reinforced fabric measured in the radial direction is thus expressed as edos_1+T+edos_2. In the particular arrangement in which edos_1=edos_2, the rubber thickness on the back of the reinforcer is simply denoted “edos” and the total thickness of the reinforced fabric measured in the radial direction is equal to T+2.edos.

The smaller the thickness of the fabric, the more the hysteresis and therefore the rolling resistance of a pneumatic tire comprising such a fabric are reduced. The rubber bridges between the reinforcing elements make it possible to take up the forces exerted on the or each ply correctly. However, an insufficient fabric thickness results in a significant risk that the rubber bridges will be imperfectly formed and therefore that the fabric will take up the forces poorly when it/they is/are used as the working ply/plies in a pneumatic tire. In addition, in a pneumatic tire, an insufficient fabric thickness results in the risk that the metal reinforcing elements of the fabric situated radially outside the hoop reinforcement will be brought closer together.

The reinforced fabric according to the invention thus preferably has, on either side of the metal reinforcing elements, rubber thicknesses on the back of the metal reinforcing elements, respectively denoted “edos_1” and “edos_2”, measured in a radial direction perpendicular to the plane formed by the transverse and main directions, such that edos_1 and edos_2 range independently of each other from 0.10 to 0.40 mm, preferably 0.10 to 0.25 mm, and more preferably 0.15 to 0.22 mm.

### Elastomer Composition

The reinforcing elements are embedded in an elastomer composition, wherein embedded is given to mean “completely coated”, with the possible exception of the section planes of the fabric.

Elastomer composition is given to mean a composition exhibiting elastomeric behavior. Such a composition is advantageously based on at least one elastomer and one other ingredient.

Preferably, the elastomer is a diene elastomer, that is, as will be recalled, any elastomer (single elastomer or mixture of elastomers) at least partially derived (i.e. a homopolymer or copolymer) from diene monomers, that is, monomers that bear two conjugated or non-conjugated carbon-carbon double bonds.

This diene elastomer is more preferably selected from the group consisting of polybutadienes (BRs), natural rubber (NR), synthetic polyisoprenes (IRs), butadiene copolymers, isoprene copolymers and mixtures of these elastomers, such copolymers being selected in particular from the group consisting of styrene-butadiene copolymers (SBRs), butadiene-isoprene copolymers (BIRs), styrene-isoprene copolymers (SIRs) and styrene-butadiene-isoprene copolymers (SBIRs).

One particularly preferred embodiment consists of using an “isoprene” elastomer, that is, an isoprene homopolymer or copolymer, in other words a diene elastomer selected from the group consisting of natural rubber (NR), synthetic polyisoprenes (IRs), the different isoprene copolymers and the mixtures of these elastomers.

The elastomer composition can comprise one or more diene elastomer(s), and also all or some of the additives usually employed in the compositions intended for the manufacturing of tires, for example reinforcing fillers such as carbon black or silica, coupling agents, anti-aging agents, antioxidants, plasticizers or extension oils, whether the latter are aromatic or non-aromatic in nature (in particular oils that are very slightly aromatic or non-aromatic, for example of the naphthene or paraffin type, with high or preferably low viscosity, MES or TDAE oils), plasticizing resins with a high glass transition temperature (greater than 30° C.), agents that improve the processability of the compositions in the green state, tackifying resins, anti-reversion agents, methylene acceptors and donors, for example HMT (hexamethylenetetramine) or HMMM (hexamethoxymethylmelamine), reinforcing resins (such as resorcinol or bismaleimide), known adhesion promoter systems of the metal salt type, for example, in particular salts of cobalt, nickel or lanthanide, and a crosslinking or vulcanization system.

Preferably, the system for crosslinking the elastomer composition is a system referred to as a vulcanization system, that is, based on sulfur (or on a sulfur donor agent) and a primary vulcanization accelerator. Various known secondary vulcanization accelerators or vulcanization activators can be added to this basic vulcanization system. Sulfur is used at a preferred content of between 0.5 and 10 phr, and the primary vulcanization accelerator, for example a sulfenamide, is used at a preferred content of between 0.5 and 10 phr. The content of reinforcing filler, for example carbon black and/or silica, is preferably greater than 30 phr, in particular between 30 and 100 phr. The term “phr” is given to mean parts by weight per hundred parts of elastomer.

All carbon blacks, in particular of the HAF, ISAF or SAF type, conventionally used in tires (“tire-grade” carbon blacks), are suitable. These include more particularly carbon blacks of 300, 600 or 700 (ASTM) grade (for example N326, N330, N347, N375, N683 or N772). Precipitated or fumed silicas having a BET surface area of less than 450 m²/g, preferably 30 to 400 m²/g, are in particular suitable as silicas.

A person skilled in the art will know, in light of the present description, how to adjust the formulation of the rubber compositions in order to achieve the desired levels of properties (in particular modulus of elasticity), and how to adapt the formulation to suit the specific application envisaged.

Preferably, the elastomer composition has, in the crosslinked state, a secant modulus in extension, at 10% elongation, of between 4 and 25 MPa, more preferably between 4 and 20 MPa; values between 5 and 15 MPa in particular have proven to be particularly suitable.

Modulus measurements are carried out under tension, unless otherwise indicated, in accordance with ASTM D412-98 (test specimen “C”): the “true” secant modulus (that is, with respect to the actual cross-section of the test specimen) is measured in second elongation (that is, after an accommodation cycle) at 10% elongation, denoted here by Ms and expressed in MPa (under standard temperature and relative humidity conditions in accordance with ASTM D1349-99).

### Pneumatic Tire

The invention also relates to a pneumatic tire comprising a crown comprising a tread, two sidewalls, and two beads, each sidewall connecting each bead to the crown, a carcass reinforcement anchored in each of the beads and extending in the sidewalls and in the crown, a crown reinforcement extending in the crown in the circumferential direction and situated radially between the carcass reinforcement and the tread, the crown reinforcement comprising a working reinforcement comprising at least first and second working plies, wherein at least one working ply is a reinforced fabric according to the invention.

Axial direction is given to mean the direction substantially parallel to the axis of rotation of the tire.

Circumferential direction is given to mean the direction substantially perpendicular both to the axial direction and to a radius of the tire (in other words, tangent to a circle centered on the axis of rotation of the tire).

Radial direction is given to mean the direction along a radius of the tire, that is, any direction that intersects the axis of rotation of the tire and is substantially perpendicular to that axis.

Circumferential mid-plane (denoted M) is given to mean the plane perpendicular to the axis of rotation of the tire, which is situated mid-way between the two beads and passes through the middle of the crown reinforcement.

In one preferred embodiment, the reinforcing elements of a first working ply form an angle ranging from 10 to 45 degrees with the circumferential direction.

In one preferred embodiment, the reinforcing elements of a second working ply form an angle ranging from 10 to 45 degrees with the circumferential direction.

Advantageously, the reinforcing elements of the first and second working plies are crossed with each other between the first working ply and the second working ply. Thus, if the angle that the reinforcing elements of the first working ply form with the circumferential direction is positive, the angle formed by the reinforcing elements of the second working ply with this same circumferential direction is negative. Conversely, if the angle that the reinforcing elements of the first working ply form with the circumferential direction is negative, the angle formed by the reinforcing elements of the second working ply with this same circumferential direction is positive.

In one preferred embodiment, the angle that the reinforcing elements of the first working ply form with the circumferential direction is, as an absolute value, substantially equal to the angle formed by the reinforcing elements of the second working ply with this same circumferential direction.

Preferably, each of the two working plies consists of a reinforced fabric according to the invention.

Preferably, the tire further comprises a hoop reinforcement comprising at least one hooping ply comprising textile reinforcing elements arranged substantially parallel to each other in the hooping ply. Preferably, these textile reinforcing elements are embedded in an elastomer composition. The hooping ply is preferably situated between the radially outermost working ply and the tread.

The textile reinforcing elements can have any known form; they can be monofilaments, but they usually consist of multifilament fibers twisted together in the form of textile cords.

Preferably, the textile reinforcing elements form an angle at most equal to 10°, preferably ranging from 5° to 10°, with the circumferential direction.

Preferably, the textile reinforcing elements are heat-shrinkable. That means that with a rise in temperature, the material forming the textile reinforcing elements shrinks. The thermal shrinkage CT of the textile reinforcing elements, measured after 2 mins at 185° C., is advantageously less than 7.5% under the test conditions set out below, preferably less than 3.5%, and more preferably less than 3%, which values have proven to be optimal for the manufacturing and dimensional stability of the tires, particularly during the phases of curing and cooling thereof. The parameter CT is measured, unless otherwise specified, in accordance with ASTM D1204-08, for example on a “TESTRITE” apparatus at a so-called standard pretension of 0.5 cN/tex (which is therefore expressed with respect to the titre or linear density of the sample tested). At constant length, the maximum shrinkage force (denoted FC) is also measured using the above test, this time at a temperature of 180° C. and at 3% elongation. This shrinkage force FC is preferably greater than 20 N (Newtons). A high shrinkage force has proven to be particularly beneficial to the hooping capability of the heat-shrinkable textile reinforcing elements with respect to the crown reinforcement of the tire when the latter heats up at high running speed.

The above parameters CT and FC can be measured without distinction on the initial adhesive-coated textile reinforcing elements before they are incorporated into the ply and the tire, or on the reinforcing elements once they have been extracted from the central zone of the vulcanized tire and preferably “derubberized” (that is, stripped of the elastomer composition in which they are embedded).

Any heat-shrinkable textile material that satisfies the shrinkage characteristics CT mentioned above is suitable. Preferably, this heat-shrinkable textile material is selected from the group consisting of polyamides, polyesters and polyketones. The polyamides include in particular polyamides 4,6, 6, 6,6, 11 or 12. The polyesters include for example PET (polyethylene terephthalate), PEN (polyethylene naphthalate), PBT (polybutylene terephthalate), PBN (polybutylene naphthalate), PPT (polypropylene terephthalate) and PPN (polypropylene naphthalate). Hybrid reinforcers made up of two (at least two) different materials such as aramid/nylon, aramid/polyester, and aramid/polyketone hybrid cords, for example, can also be used provided that they satisfy the recommended characteristic CT.

In the reinforced fabric according to the invention, the different geometric characteristics such as the thicknesses edos_1 and edos_2, laying pitch p, length W, and height T are measured in a central portion of the fabric in the green, i.e. non-vulcanized, state, over a total axial width of 4 cm, by calculating an average of all of the reinforcing elements present.

In the pneumatic tire according to the invention, the different geometric characteristics such as the thicknesses edos_1 and edos_2, laying pitch p, length W, and height T are measured in the central portion of the crown reinforcement of the tire in the vulcanized state, on either side of the mid-plane M over a total axial width of 4 cm, by calculating an average of all of the reinforcing elements present in the central portion of the working reinforcement, in an axial interval extending between −2 cm and +2 cm relative to the mid-plane M.

### DESCRIPTION OF THE FIGURES

FIG. 1 is a schematic view of a portion of reinforced fabric according to the invention, This FIGURE shows, in a section plane perpendicular to the main direction of the metal reinforcing elements, three reinforcing elements of width W and height or thickness T, wherein these elements are juxtaposed at a laying pitch p and embedded in an elastomer composition so that the fabric has, on either side of each reinforcing element in a radial direction, a rubber thickness denoted “edos_1” and “edos_2” respectively.

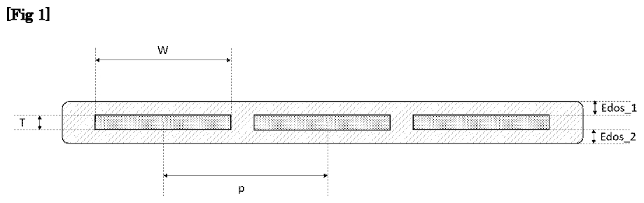

### MEASUREMENT METHODS

The absolute breaking force of a ply, expressed in N, is measured by multiplying the number of reinforcing elements present over a length of 10 cm of the ply in the transverse direction by the individual breaking force of each reinforcing element. The measurements of breaking force, breaking strength denoted R_{F} (in MPa), and elongation at break denoted At (total elongation as a %) are taken under tension in accordance with ISO 6892:1984.

The breaking force of the ply is obtained by dividing the absolute breaking force of the ply determined as indicated above by 100, and is expressed in N/mm.

The torsional elastic deformation is measured over a given length of metal reinforcing element, for example a length ranging from 5 to 10 m, and the value found is expressed relative to 6 m in order to obtain the value C. To this end, a very long table is provided, the length of the table being at least equal to the length of metal reinforcer the torsional elastic deformation of which is being measured, and one end of the metal reinforcer is fastened to one end of the table. The metal reinforcer is unwound taking great care to hold the metal reinforcer in order to prevent it from rotating on itself about its main axis. At the other end, the metal reinforcer is hung on the edge of the table and a rod is fastened to its end perpendicular to the main axis of the metal reinforcer. The hanging end of the metal reinforcer is then allowed to rotate freely. The number of turns that the rod makes is then measured. If the rod makes an incomplete turn, the angle traveled on that turn is expressed as the non-whole value of the turn. Thus, an angle of 180° will be expressed 0.5 of a turn.

The bending stiffness is estimated, for a reinforcing element with a circular cross-section, by the equation Y.d⁴/64, where d is the diameter of the reinforcing element with a circular cross-section and Y is the Young's modulus of the element. By construction, a reinforcing element with a circular cross-section has the same edgewise and out-of-plane bending stiffness.

The bending stiffness is estimated, for a reinforcing element of length W and height T, by the equation Y.T.W³/12 for edgewise bending stiffness and Y.W.T³/12 for out-of-plane bending stiffness, where Y is the Young's modulus of the element.

### EXAMPLES

The following tests show the advantages of the reinforced fabrics according to the invention.

Fabrics T1 and T3 are fabrics of the prior art implementing individual metal monofilaments as reinforcing elements, having a diameter of 0.32 mm for T1 and a diameter of 0.35 mm for T2. Fabric T2 is a fabric having the same thickness as the fabric according to the invention C1.

Fabrics C1 and T1, and C3 and T3, have the same inter-cable distance. Fabric T2 is the same thickness as fabric C1. Fabric C2 has the same mass per 1 m² of fabric as fabric T2. Fabric C4 comprises the same metal reinforcing elements as fabric C3 and has the same ply strength as fabric T3.

With respect to mass, the results are given in base 100 relative to fabric T1 for fabrics C1, T2 and C2, and relative to fabric T3 for fabrics C3 and C4. A value greater than 100 means that the fabric has a mass greater than the mass of the reference fabric, and a value less than 100 means that the fabric has a mass less than the mass of the reference fabric. A greater fabric mass results in greater rolling resistance of a pneumatic tire comprising such a fabric.

TABLE 1

| | T1 | C1 | T2 | C2 | T3 | C3 | C4 |
|---|---|---|---|---|---|---|---|
| Width W (mm) | 0.32 | 0.42 | 0.25 | 0.53 | 0.35 | 0.6 | 0.6 |
| Height T (mm) | 0.32 | 0.25 | 0.25 | 0.21 | 0.35 | 0.3 | 0.3 |
| 1/a = T/W | 1.0 | 0.60 | 1.00 | 0.40 | 1.00 | 0.50 | 0.50 |
| Breaking force Rn (N/mm) | 350 | 350 | 350 | 350 | 350 | 437.5 | 350 |
| Laying pitch p (mm) | 0.79 | 0.89 | 0.50 | 0.97 | 0.93 | 1.17 | 1.47 |
| Inter-cable distance (mm) | 0.47 | 0.47 | 0.25 | 0.44 | 0.58 | 0.57 | 0.87 |
| Fabric thickness (mm) | 0.72 | 0.65 | 0.65 | 0.61 | 0.75 | 0.7 | 0.7 |

Implementation in pneumatic tire - Base 100

| | | | | | | | |
|---|---|---|---|---|---|---|---|
| Out-of-plane bending stiffness | 100 | 94 | 59 | 65 | 100 | 145 | 116 |
| Edgewise bending stiffness | 100 | 261 | 59 | 403 | 100 | 581 | 465 |
| Rolling resistance | 100 | 95 | 93 | 93 | 100 | 110 | 99 |

1-15. (canceled)

16. A reinforced fabric comprising a plurality of substantially parallel metal reinforcing elements extending in a main direction, arranged in a transverse direction perpendicular to the main direction at a laying pitch p expressed in mm,
embedded in an elastomer composition based on at least one elastomer, a reinforcing filler, and a crosslinking system,
each metal reinforcing element having, in a plane perpendicular to the main direction, a cross-section inscribed in a rectangle of length W and height T and having a breaking strength R_{F} expressed in MPa and measured in accordance with ISO 6892:1984,
the reinforced fabric having a breaking force expressed in N/mm equal to Rₙ,
wherein the laying pitch of the metal reinforcing elements is p≥0.8·R_{F}/Rₙ·(a−1+π/4)·T², where a=W/T and 1/a ranges from 0.35 to 0.75.

17. The reinforced fabric as claimed in claim 16, wherein 1/a ranges from 0.35 to 0.65.

18. The reinforced fabric as claimed in claim 16, wherein the height T ranges from 0.15 mm to 0.70 mm.

19. The reinforced fabric as claimed in claim 16, wherein the laying pitch p is such that p≤1.2·R_{F}/Rₙ·(a−1+π/4)·T².

20. The reinforced fabric as claimed in claim 16, wherein each metal reinforcing element is at least high tensile grade having a breaking strength R_{F} greater than or equal to 3,650-2,000·D, where D, expressed in mm, is equal to (T+W)/2.

21. The reinforced fabric as claimed in claim 16, wherein each metal reinforcing element is at least super high tensile grade having a breaking strength R_{F} greater than or equal to 4,000-2,000·D, where D, expressed in mm, is equal to (T+W)/2.

22. The reinforced fabric as claimed in claim 16, wherein each metal reinforcing element is at least ultra high tensile grade having a breaking strength R_{F} greater than or equal to 4,350-2,000·D, where D, expressed in mm, is equal to (T+W)/2.

23. The reinforced fabric as claimed in claim 16, further comprising, on either side of the metal reinforcing elements, rubber thicknesses on a back of the metal reinforcing elements, denoted edos_1 and edos_2, measured in a radial direction perpendicular to the plane formed by the transverse and main directions, such that edos_1 and edos_2 range independently of each other from 0.10 to 0.40 mm.

24. The reinforced fabric as claimed in claim 16, wherein each reinforcing element comprises a steel core covered with a metal coating layer made from a metal other than steel.

25. The reinforced fabric as claimed in claim 16, wherein each reinforcing element has a torsional elastic deformation C, expressed as an absolute value, less than or equal to 6 turns per 6 m of metal reinforcer.

26. The reinforced fabric as claimed in claim 16, wherein Rₙ is greater than or equal to 220 N/mm.

27. The reinforced fabric as claimed in claim 16, wherein the elastomer of the elastomer composition is a diene elastomer.

28. A pneumatic tire comprising a crown comprising a tread, two sidewalls, and two beads, each sidewall connecting each bead to the crown, a carcass reinforcement anchored in each of the beads and extending in the sidewalls and in the crown, a crown reinforcement extending in the crown in the circumferential direction and situated radially between the carcass reinforcement and the tread, the crown reinforcement comprising a working reinforcement comprising at least first and second working plies, wherein at least one working ply is the reinforced fabric as claimed in claim 16.

29. The pneumatic tire as claimed in claim 28, wherein each first and second working ply consists of the reinforced fabric.

30. The pneumatic tire as claimed in claim 28, further comprising a hoop reinforcement comprising at least one hooping ply comprising textile reinforcing elements arranged substantially parallel to each other in the hooping ply.
